(19) United States
(12) Patent Application Publication
(10) Pub. No.: US 2003/0054184 A1
(43) Pub. Date: Mar. 20, 2003

(54) Optical element, method for the production thereof and optical module

(75) Inventors: Nobuo Miyadera, Tsukuba-Shi (JP); Tooru Takahashi, Tsukuba-Shi (JP); Yutaka Honda, Tsukuba-Shi (JP); Shigeru Koibuchi, Tsukuba-Shi (JP); Tatemi Ido, Kokubunji-Shi (JP); Shinji Tsuji, Kokubunji-Shi (JP); Takamitsu Nagara, Kokubunji-Shi (JP)

Correspondence Address: GRIFFIN & SZIPL, PC, SUITE PH-1, 2300 NINTH STREET, SOUTH, ARLINGTON, VA, 22204, US

(73) Assignee: Hitachi Chemical Co., Ltd., Tokyo (JP)

(21) Appl. No.: 10/259,660

(22) Filed: Sep. 30, 2002

Related U.S. Application Data
(63) Continuation of application No. 09/946,669, filed on Sep. 6, 2001, now abandoned.

(51) Int. Cl. B32B 27/00

(52) U.S. Cl. 428/473.5

(57) ABSTRACT

The invention provides an optical element comprising a substrate having provided thereon a coating of an organic zirconium compound, a coating of a fluorine-free polyimide resin and a coating of a fluorine-containing polyimide resin, in this order. The element has increased adhesive property with the substrate and reliability.

### FIELD OF THE INVENTION

This invention relates to an optical element comprising a fluorine-containing polyimide resin, a method for the production thereof and an optical module.

### BACKGROUND OF THE INVENTION

A fluorine-containing polyimide resin has been applied to an optical device because it has higher light transmission and lower refractive index than a fluorine-free polyimide resin. For example, JP-A-4-235506 discloses a method for the production of an optical device wherein an optical waveguide is prepared by providing a silicone substrate whose surface is coated with a silicon oxide film, forming a first fluorine-containing polyimide resin film and a second fluorine-containing polyimide resin film having a refractive index different from the first polyimide resin film on the substrate and then conducting a patterning.

As described above, by the use of the fluorine-containing polyimide, it is possible to obtain an optical device by simpler process as compared with a case wherein an inorganic material such as glass is used. However, the fluorine-containing polyimide has disadvantages in that it is low in adhesive property to a substrate surface on which a resin coating is formed, such as glass, quartz, silicon, silicon oxide, silicon nitride, aluminum, aluminum oxide, aluminum nitride, tantalum oxide, gallium arsenide and the like and therefore it is low in reliability when it is used for a long period of time.

To solve the above problems, JP-A-7-174930 discloses a method for the production of an optical device wherein a coating of an organic zirconium compound is formed on a substrate and then a coating of a fluorine-containing polyimide resin is formed on the coating of the organic zirconium compound.

However, the coating of the organic zirconium compound alone cannot give sufficient adhesive property. In particular, in an optical device such as those used in optical communication systems, which is required to have high reliability for a long period of time, it is required that the coating does not peel off for at least 200 hours in an accelerated test such as the Pressure-Cooker Test (121° C. at 2 atmospheric pressure). The adhesive property of the coating of the above patent is insufficient. The adhesive property depends on the kind of a substrate, and the kind of a resin of a fluorine-containing polyimide resin coating. For example, the adhesive property will be insufficient if there is big difference in thermal expansion coefficient between the substrate and the fluorine-containing polyimide resin coating, if a coating of a polyimide resin containing a large amount of fluorine is used, or if the total thickness of resin coating is large.

### SUMMARY OF THE INVENTION

A first object of the present invention is to provide an optical element having high reliability.

A second object of the present invention is to provide a method for the production of the optical element having high reliability.

A third object of the present invention is to provide an optical module using the optical element having high reliability.

The optical element having high reliability can be produced by increasing the adhesive property of a fluorine-containing polyimide resin coating which has been used as a material for an optical device, to a substrate.

According to a first aspect of the present invention, there is provided an optical element comprising a substrate having provided thereon a coating of an organic zirconium compound, a coating of a fluorine-free resin and a coating of a fluorine-containing polyimide resin, in this order.

According to a second aspect of the present invention, there is provided a method for the production of an optical element comprising the steps of providing a substrate; forming a coating of an organic zirconium compound on the surface of the substrate; forming a coating of a fluorine-free resin on the coating of the organic zirconium compound and forming a coating of a fluorine-containing polyimide resin on the coating of the fluorine-free resin.

According to a third aspect of the present invention, there is provided an optical module comprising a polymer optical waveguide comprising a substrate having provided thereon a coating of an organic zirconium compound, a coating of a fluorine-free resin and a coating of a fluorine-containing polyimide resin, in this order, and at least one of a light emitting element, a light detecting element and an optical fiber is provided at one or both ends of the polymer optical waveguide.

The coating of the fluorine-free resin has a thickness of preferably 10 μm or less, more preferably 1.0 μm or less.

According to the present invention wherein a coating of an organic zirconium compound, a coating of a fluorine-free resin and a coating of a fluorine-containing polyimide resin are provided on a substrate in this order, the problems described earlier are eliminated. The optical element of the present invention has high adhesive property and long time stability.

### BRIEF DESCRIPTION OF THE DRAWINGS

FIG. 1 is a graph showing the test results of the adhesive property for the optical waveguides of Examples and Comparative Examples.

FIG. 2 is a perspective view of a channel polymer optical waveguide of the present invention.

FIG. 3 is a perspective view of a ridge optical waveguide having no upper cladding layer.

FIG. 4 is a perspective view of a channel optical waveguide.

FIG. 5 is a perspective view of another channel optical waveguide.

FIG. 6(a) is a plan view of an optical switch which is an example of a polymer optical integrated circuit.

FIG. 6(b) is a A-A′ sectional view of FIG. 6 (a).

FIG. 7 is a plan view explaining the constitution of the optical switch.

FIG. 8 is a plan view explaining the constitution of the optical communication system.

FIG. 9 is a perspective view of an optical waveguide of the prior art

FIG. 10 is a perspective view of an optical waveguide containing a fluorine-free resin layer alone.

FIG. 11 is a perspective view of an optical waveguide containing an organic zirconium compound coating alone.

### PREFERRED EMBODIMENT OF THE INVENTION

The words “optical element” in this specification means an optical device such as optical waveguide, optical splitter, light distributing guide, optical attenuator, light diffraction device, optical amplifier, optical interference device, optical filter, optical switch, wavelength converter, light emitting element, light detecting element, and combinations of two or more of the above elements provided on a substrate such as inorganic material such as glass and quartz, semiconductor or metal material such as silicon, gallium arsenide, aluminum, and titanium, polymeric material such as polyimide and polyamide, or composite materials thereof.

On the substrate, there may be provided semiconductor device such as light emitting diode, and photo diode, or metallic film. There may also be provided on the substrate a coating of silicon oxide, silicon nitride, aluminum oxide, aluminum nitride, tantalum oxide, or the like to protect the substrate or to adjust refractive index.

Preferable examples of the organic zirconium compounds used in the present invention include zirconium esters and zirconium chelate compounds.

Examples of zirconium esters include tetrapropyl zirconate, tetrabutyl zirconate, and the like.

Examples zirconium chelate compounds include tetrakis(acetylacetonate) zirconium, monobutoxytris(acetylacetonate) zirconium, dibutoxybis(acetylacetonate) zirconium, tributoxy(acetylacetonate) zirconium, tetra(ethylacetylacetate) zirconium, monobutoxytris (ethylacetylacetate) zirconium, dibutoxybis(ethylacetylacetate) zirconium, tributoxy(ethylacetylacetate) zirconium, tetrakis(ethyllactonate) zirconium, bis(bisacetylacetonate)bis(ethylacetylacetonate) zirconium, mono (acetylacetonate)tris(ethylacetylacetonate) zirconium, and monobutoxy monoacetylacetonate bis(ethylacetylacetonate) zirconium.

Zirconium esters and zirconium chelate compounds used in the invention are not limited to those described above but any compounds can be used as long as they contain zirconium oxide when a coating is formed. The zirconium esters and the zirconium chelate compounds can be used alone or in combination.

Organic zirconium compounds are dissolved in an organic solvent such as methanol, ethanol, butanol, benzene, toluene, N-methyl-2-pyrrolidone, N,N-dimethylacetamide, or γ-butyrolactone, water or the lice. The solution is coated on the substrate surface by spin coating method and dried at 70-400° C. to form a coating. The thickness of the coating of the organic zirconium compound is preferably not more than 3000 Angstroms because the coating becomes brittle if it is too thick.

Examples of the fluorine-free resins used in the present invention include polyimide resins, silicone resins, acrylic resins, polycarbonate resins, epoxy resins, polyamide resins, polyester resins, phenol resins, and the like. One can select appropriate resins having good adhesive property to the substrate used. If the optical element is required to have heat resistance during the production or the use thereof, polyimide resins and polyquinoline resins are preferred. The fluorine-free resins are preferably nitrogen-containing resins.

Examples of the fluorine-free polyimide resins include polyimide resins, poly(imide-isoindoloquinazolinedioneimide) resins, polyetherimide resins, polyamideimide resins, polyesterimide resins, and the like.

The fluorine-free resins used in the present invention may be a resin whose fluorine content is zero, or a resin whose fluorine content is significantly low as compared with the fluorine content of fluorine-containing resins. In the latter case, the fluorine content is preferably less than half of the content in the core formed from the fluorine-containing polyimide resin, more specifically not more than 10% by weight, more preferably not more than 2% by weight.

Examples of the fluorine-containing polyimide resins used in the present invention include fluorine-containing polyimide resins, fluorine-containing poly(imide-isoindoloquinazolinedioneimide) resins, fluorine-containing polyetherimide resins, fluorine-containing polyamideimide resins, and the like.

Polyamideimide resins may be prepared by the use of chlorinated trimellitic anhydride, or the like.

A solution of a precursor of a polyimide resin may be obtained by a reaction of a tetracarboxylic dianhydride with a diamine in a polar solvent such as N-methyl-2-pyrrolidone, N,N-dimethylacetamide, γ-butyrolactone, dimethyl sulfoxide, and the like.

A solution of a precursor of a fluorine-containing polyimide resin may be obtained by a reaction of a fluorine-containing tetracarboxylic dianhydride with a diamine.

A solution of a precursor of a fluorine-containing polyimide resin may be obtained by a reaction of a tetracarboxylic dianhydride with a fluorine-containing diamine.

A solution of a precursor of a fluorine-free polyimide resin may be obtained by a reaction of a fluorine-free tetracarboxylic dianhydride with a fluorine-free diamine.

Examples of fluorine-containing tetracarboxylic dianhydrides include (trifluoromethyl) pyromellitic dianhydride, di(trifluoromethyl) pyromellitic dianhydride, di(heptafluoropropyl) pyromellitic dianhydride, pentafluoroethyl pyromellitic dianhydride, bis{3,5-di(trifluoromethyl)phenoxy}pyromellitic dianhydride, 2,2-bis(3,4-dicarboxyphenyl)hexafluoropropane dianhydride, 5,5′-bis(trifluoromethyl)-3,3′,4,4′-tetracarboxybiphenyl dianhydride, 2,2′,5,5′-tetrakis(trifluoromethyl)-3,3′,4,4′-tetracarboxybiphenyl dianhydride, 5,5′-bis(trifluoromethyl)-3,3′,4,4′-tetracarboxydiphenylether dianhydride, 5,5′-bis(trifluoromethyl)-3,3′,4,4′-tetracarboxybenzophenone dianhydride, bis {(trifluoromethyl)dicarboxyphenoxy}benzene dianhydride, bis {(trifluoromethyl)dicarboxyphenoxy}(trifluoromethyl)benzene dianhydride, bis(dicarboxyphenoxy)(trifluoromethyl)benzene dianhydride, bis (dicarboxyphenoxy)bis(trifluoromethyl)benzene dianhydride, bis (dicarboxyphenoxy)tetrakis(trifluoromethyl)benzene dianhydride, 2,2-bis{(4-(3,4-dicarboxyphenoxy)phenyl}hexafluoropropane dianhydride, bis {(trifluoromethyl)dicarboxyphenoxy}biphenyl dianhydride, bis {(trifluoromethyl)dicarboxyphenoxy}bis(trifluoromethyl)biphenyl dianhydride, bis{(trifluoromethyl)dicarboxyphenoxy}diphenylether dianhydride, bis(dicarboxyphenoxy)bis(trifluoromethyl)biphenyl dianhydride, 1,4-bis(2-hydroxyhexafluoroisopropyl)benzene bis(trimellitic anhydride), 1,3-bis(2-hydroxyhexafluoroisopropyl)benzene bis(trimellitic anhydride), and the like.

Examples of the fluorine-free tetracarboxylic dianhydrides include pyromellitic dianhydride, benzene 1,2,3,4-tetracarboxylic dianhydride, 3,3′,4,4′-diphenyltetracarboxylic dianhydride, 2,2′,3,3′-diphenyltetracarboxylic dianhydride, 2,3,3′,4′-diphenyltetracarboxylic dianhydride, p-ter-phenyl-3,4,3″,4″-tetracarboxylic dianhydride, m-ter-phenyl-3,4,3″,4″-tetracarboxylic dianhydride, 1,2,5,6-naphthalene tetracarboxylic dianhydride, 2,3,6,7-naphthalene tetracarboxylic dianhydride, 1,2,4,5-naphthalene tetracarboxylic dianhydride, 1,4,5,8-naphthalene tetracarboxylic dianhydride, 2,6-dichloronaphthalene 1,4,5,8-tetracarboxylic dianhydride, 2,7-dichloronaphthalene 1,4,5,8-tetracarboxylic dianhydride, 2,3,6,7-tetrachloronaphthalene 1,4,5,8-tetracarboxylic dianhydride, 2,3,5,6-pyridine tetracarboxylic dianhydride, 3,4,9,10-perylene tetracarboxylic dianhydride, 3,3′,4,4′-benzophenone tetracarboxylic dianhydride, 2,2′,3,3′-benzophenone tetracarboxylic dianhydride, 2,3,3′,4-benzophenone tetracarboxylic dianhydride, 3,3′,4,4′-biphenylether tetracarboxylic dianhydride, 4,4′-sulfonyldiphthalic dianhydride, 3,3′,4,4′-tetraphenylsilane tetracarboxylic dianhydride, 3,3′,4,4′-diphenylether tetracarboxylic dianhydride, 1,3-bis(3,4-dicarboxyphenyl)-1,1,3,3-tetramethyldisiloxane dianhydride, 1-(2,3-dicarboxyphenyl)-3-(3,4-dicarboxyphenyl)-1,1,3,3-tetramethyldisiloxane dianhydride, 2,2-bis(3,4-dicarboxyphenyl)propane dianhydride, 2,2-bis(2,3-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, bis(3,4-dicarboxyphenyl)sulfone dianhydride, phenanthrene 1,8,9,10-tetracarboxylic dianhydride, pyrazine 2,3,5,6-tetracarboxylic dianhydride, thiophene 2,3,4,5-tetracarboxylic dianhydride, bis(3,4-dicarboxyphenyl) dimethylsilane dianhydride, bis(3,4-dicarboxyphenyl) methylphenylsilane dianhydride, bis(3,4-dicarboxyphenyl)diphenylsilane dianhydride, 1,4-bis(3,4-dicarboxyphenyldimethylsilyl)benzene dianhydride, 1,3-bis(3,4-dicarboxyphenyl)-1,1,3,3-tetramethyldicyclohexane dianhydride, p-phenyl bis(trimellitic monoester anhydride), ethyleneglycol bis(trimellitic anhydride), propanediol bis(trimellitic anhydride), butanediol bis(trimellitic anhydride), pentanediol bis(trimellitic anhydride), hexanediol bis(trimellitic anhydride), octanediol bis(trimellitic anhydride), decanediol bis(trimellitic anhydride), ethylene tetracarboxylic dianhydride, 1,2,3,4-butane tetracarboxylic dianhydride, decahydronaphthalene 1,4,5,8-tetracarboxylic dianhydride, 4,8-dimethyl-1,2,3,5,6,7-hexahydronaphthalene 1,2,5,6-tetracarboxylic dianhydride, cyclopentane 1,2,3,4-tetracarboxylic dianhydride, pyrrolidine 2,3,4,5-tetracarboxylic dianhydride, 1,2,3,4-cyclobutane tetracarboxylic dianhydride, bis(exo-bicyclo[2,2,1]heptane-2,3-dicarboxylic anhydride)sulfone, bicyclo-(2,2,2)-octo(7)-ene-2,3,5,6-tetracarboxylic dianhydride, 4,4′-bis(3,4-dicarboxyphenoxy)diphenylsulfide dianhydride, 5-(2,5-dioxotetrahydrofuryl)-3-methyl-3-cyclohexene-1,2-dicarboxylic anhydride, tetrahydrofuran 2,3,4,5-tetracarboxylic dianhydride and the like. The anhydride may be used alone or in combination.

Examples of the fluorine-containing diamines include 4-(1H,1H,11H-eicosafluoroundecanoxy)-1,3-diaminobenzene, 4-(1H,1H-perfluoro-1-butanoxy)-1,3-diaminobenzene, 4-(1H,1H-perfluoro-1-heptanoxy)-1,3-diaminobenzene, 4-(1H,1H-perfluoro-1-octanoxy)-1,3-diaminobenzene, 4-pentafluoro phenoxy-1,3-diaminobenzene, 4-(2,3,5,6-tetrafluorophenoxy)-1,3-diamino benzene, 4-(4-fluorophenoxy)-1,3-diaminobenzene, 4-(1H,1H,2H,2H-perfluoro-1-hexanoxy)-1,3-diaminobenzene, 4-(1H,1H,2H,2H-perfluoro-1-dodecanoxy)-1,3-diaminobenzene, (2,5-diamino)benzotrifluoride, bis(trifluoromethyl) phenylenediamine, diaminotetra(trifluoromethyl)benzene, diamino (pentafluoroethyl)benzene, 2,5-diamino(perfluorohexyl)benzene, 2,5-diamino(perfluorobutyl)benzene, 1,4-bis(4-aminophenyl)benzene, p-bis(4-amino-2-trifluoromethylphenoxy) benzene, bis(aminophenoxy)bis (trifluoromethyl) benzene, bis(aminophenoxy)tetrakis(trifluoromethyl) benzene, bis{2-[(aminophenoxy)phenyl]hexafluoroisopropyl}benzene, 2,2′-bis(trifluoromethyl)-4,4′-diaminobiphenyl, 3,3′-bis(trifluoromethyl)-4,4′diaminobiphenyl, octafluorobenzidine, bis{(trifluoromethyl)aminophenoxy}biphenyl, 4,4′-bis(4-amino-2-trifluoromethylphenoxy)biphenyl, 4,4′-bis(4-amino-3-trifluoromethylphenoxy)biphenyl, 1,4-bis(anilino)octafluorobutane, 1,5-bis(anilino)decafluoropentane, 1,7-bis(anilino)tetradecafluoroheptane, 3,3′-difluoro-4,4′-diaminodiphenylether, 3,3′,5,5′-tetrafluoro-4,4′-diamino diphenylether, 2,2′-bis(trifluoromethyl)-4,4′-diaminodiphenylether, 3,3′-bis (trifluoromethyl)-4,4′-diaminodiphenylether, 3,3′,5,5′-tetrakis(trifluoromethyl)-4,4′-diaminodiphenylether, 3,3′-difluoro-4,4′-diamino diphenylmethane, 3,3′-di(trifluoromethyl)-4,4′-diamino diphenylmethane, 3,3′,5,5′-tetrafluoro-4,4′-diaminodiphenylmethane, 3,3′,5,5′-tetrakis (trifluoromethyl)-4,4′-diaminodiphenylmethane, 3,3′-difluoro-4,4′-diamino diphenylpropane, 3,3′,5,5′-tetrafluoro-4,4′-diaminodiphenylpropane, 3,3′-bis(trifluoromethyl)-4,4′-diaminodiphenylpropane, 3,3′,5,5′-tetra (trifluoromethyl)-4,4′-diaminodiphenylpropane, 3,3′-difluoro-4,4′-diamino diphenylsulfone, 3,3′,5,5′-tetrafluoro-4,4′-diaminodiphenylsulfone, 3,3′-bis(trifluoromethyl)-4,4′-diaminodiphenylsulfone, 3,3′,5,5′-tetrakis (trifluoromethyl)-4,4′-diaminodiphenylsulfone, 4,4′-bis(4-amino-2-trifluoro (methylphenoxy)diphenylsulfone, 4,4′-bis(3-amino-5-trifluoromethylphenoxy) diphenylsulfone, 3,3′-difluoro-4,4′-diaminodiphenylsulfide, 3,3′,5,5′-tetrafluoro-4,4′-diaminodiphenylsulfide, 3,3′-bis(trifluoromethyl)-4,4′-diamino diphenylsulfide, 3,3′,5,5′-tetrakis(trifluoromethyl)-4,4′-diaminodiphenyl sulfide, 3,3′-difluoro-4,4′-diaminobenzophenone, 3,3′,5,5′-tetrafluoro-4,4′-diaminobenzophenone, 3,3′-bis(trifluoromethyl)-4,4′-diaminobenzophenone, 3,3′,5,5′-tetra(trifluoromethyl)-4,4′-diaminobenzophenone, 4,4′-diamino-p-terphenyl, 3,3′-dimethyl-4,4′-diaminodiphenylhexafluoropropane, 3,3′-dimethoxy-4,4′-diaminodiphenylhexafluoropropane, 3,3′-diethoxy-4,4′-diaminodiphenylhexafluoropropane, 3,3′-difluoro-4,4′-diaminodiphenyl hexafluoropropane, 3,3′-dichoro-4,4′-diaminodiphenylhexafluoropropane, 3,3′-dibromo-4,4′-diaminodiphenylhexafluoropropane, 3,3′,5,5′-tetramethyl-4,4′-diaminodiphenylhexafluoropropane, 3,3′,5,5′-tetramethoxy-4,4′-diaminodiphenylhexafluoropropane, 3,3′,5,5′-tetraethoxy-4,4′-diaminodiphenyl hexafluoropropane, 3,3′,5,5′-tetrafluoro4,4′-diaminodiphenylhexafluoro propane, 3,3′,5,5′-tetrachloro-4,4′-diaminodiphenylhexafluoropropane, 3,3′,5,5′-tetrabromo-4,4′-diaminodiphenylhexafluoropropane, 3,3′,5,5′-tetrakis (trifluoromethyl)-4,4′-diaminodiphenylhexafluoropropane, 3,3′-bis (trifluoromethyl)-4,4′-diaminodiphenylhexafluoropropane, 2,2-bis(4-aminophenyl)hexafluoropropane, 1,3-bis(anilino)hexafluoropropane, 2,2-bis{4-(4-aminophenoxy)phenyl}hexafluoropropane, 2,2-bis{4-(3-aminophenoxy)phenyl} hexafluoropropane, 2,2-bis{4-(2-aminophenoxy)phenyl}hexafluoropropane, 2,2-bis{4-(4-aminophenoxy)-3,5-ditrifluoromethylphenyl}hexafluoropropane, 2,2-bis{4-(4-aminophenoxy)-3,5-ditrifluoromethylphenyl}hexafluoropropane, 2,2-bis{4-(4-amino-3-trifluoromethylphenoxy)phenyl}hexafluoropropane, bis [{(trifluoromethyl)aminophenoxy}phenyl]hexafluoropropane, 1,3-amino-5-(perfluorononenyloxy)benzene, 1,3-diamino-4-methyl-5-(perfluorononenyloxy) benzene, 1,3-diamino-4-methoxy-5-(perfluorononenyloxy)benzene, 1,3-diamino-2,4,6-trifluoro-5-(perfluorononenyloxy)benzene, 1,3-diamino-4-chloro-5-(perfluorononenyloxy)benzene, 1,3-diamino-4-bromo-5-(perfluorononenyloxy)benzene, 1,2-diamino-4-(perfluorononenyloxy)benzene, 1,2-diamino-4-methyl-5-(perfluorononenyloxy)benzene, 1,2-diamino-4-methoxy-5-(perfluorononenyloxy)benzene, 1,2-diamino-3,4,6-trifluoro-5-(perfluorononenyloxy)benzene, 1,2-diamino-4-chloro-5-(perfluorononenyloxy) benzene, 1,2-diamino-4-bromo-5-(perfluoro nonenyloxy) benzene, 1,4-diamino-3-(perfluorononenyloxy) benzene, 1,4-diamino-2-methyl-5-(perfluorononenyloxy)benzene, 1,4-diamino-2-methoxy-5-(perfluorononenyloxy)benzene, 1,4-diamino-2,3,6-trifluoro-5-(perfluorononenyloxy)benzene, 1,4-diamino-2-chloro-5-(perfluorononenyloxy)benzene, 1,4-diamino-2-bromo-5-(perfluorononenyloxy)benzene, 1,3-diamino-5-(perfluorohexenyloxy)benzene, 1,3-diamino-4-methyl-5-(perfluorohexenyloxy)benzene, 1,3-diamino-4-methoxy-5-(perfluorohexenyloxy)benzene, 1,3-diamino-2,4,6-trifluoro-5-(perfluorohexenyloxy)benzene, 1,3-diamino-4-chloro-5-(perfluorohexenyloxy) benzene, 1,3-diamino-4-bromo-5-(perfluorohexenyloxy)benzene, 1,2-diamino-4-(perfluorohexenyloxy)benzene, 1,2-diamino-4-methyl-5-(perfluoro hexenyloxy)benzene, 1,2-diamino-4-methoxy-5-(perfluorohexenyloxy)benzene, 1,2-diamino-3,4,6-trifluoro-5-(perfluorohexenyloxy)benzene, 1,2-diamino-4-chloro-5-(perfluorohexenyloxy)benzene, 1,2-diamino-4-bromo-5-(perfluorohexenyloxy)benzene, 1,4-diamino-3-(perfluorohexenyloxy)benzene, 1,4-diamino-2-methyl-5-(perfluorohexenyloxy)benzene, 1,4-diamino-2-methoxy-5-(perfluorohexenyloxy)benzene, 1,4-diamino-2,3 ,6-trifluoro-5-(perfluorohexenyloxy)benzene, 1,4-diamino-2-chloro-5-(perfluorohexenyloxy)benzene, 1,4-diamino-2-bromo-5-(perfluorohexenyloxy)benzene, and the like.

The diamine may be used alone or in combination.

Examples of the fluorine-free diamines include p-phenylenediamine, m-phenylenediamine, 2,6-diaminopyridine, 1,5-diaminonaphthalene, 2,6-diaminonaphthalene, benzidine, 3,3′-dimethylbenzidine, 3,3′-dimethoxy benzidine, 3,3′-diaminobenzophenone, 3,3′-dimethyl-4,4′-diamino benzophenone, 3,3′-dimethoxy-4,4′diaminobenzophenone, 3,3′-diethoxy-4,4′-diaminobenzophenone, 3,3′-dichloro-4,4′-diaminobenzophenone, 3,3′-dibromo-4,4′-diaminobenzophenone, 3,3′,5,5′-tetramethyl-4,4′-diaminobenzophenone, 3,3′,5,5′-tetramethoxy-4,4′-diaminobenzophenone, 3,3′,5,5′-tetraethoxy-4,4′-diaminobenzophenone, 3,3′,5,5′-tetrachloro-4,4′-diaminobenzophenone, 3,3′,5,5′-tetabromo-4,4′-diaminobenzophenone, 4,4′-diaminodiphenylether, 3,4′-diaminodiphenylether, 3,3′-diaminodiphenylether, 3,3′-dimethyl-4,4′-diaminodiphenylether, 3,3′-diisopropyl-4,4′-diaminodiphenylether, 3,3′-dimethoxy-4,4′-diaminodiphenylether, 3,3′-diethoxy-4,4′-diaminodiphenylether, 3,3′-dichloro-4,4′-diaminodiphenylether, 3,3′-dibromo-4,4′-diaminodiphenylether, 3,3′,5,5′-tetramethyl-4,4′-diaminodiphenylether, 3,3′,5,5′-tetraethyl-4,4′-diaminodiphenylether, 3,3′,5,5′-tetramethoxy-4,4′-diaminodiphenylether, 3,3′,5,5′-tetraethoxy-4,4′-diaminodiphenylether, 3,3′,5,5′-tetrachloro-4,4′-diaminodiphenylether, 3,3′,5,5′-tetrabromo-4,4′-diaminodiphenylether, 3,3′-diisopropyl-5,5′-dimethyl-4,4′-diaminodiphenylether, 3,3′-diisopropyl-5,5′-diethyl-4,4′-diaminodiphenylether, 4,4′-diaminodiphenylmethane, 3,3′-diaminodiphenylmethane, 3,3′-dimethyl-4,4′-diaminodiphenylmethane, 3,3′-diethyl-4,4′-diaminodiphenylmethane, 3,3′-dimethoxy-4,4′-diaminodiphenylmethane, 3,3′-diethoxy-4,4′-diaminodiphenylmethane, 3,3′-dichloro-4,4′-diaminodiphenylmethane, 3,3′-dibromo-4,4′-diaminodiphenylmethane, 3,3′,5,5′-tetramethyl-4,4′-diaminodiphenylmethane, 3,3′,5,5′-tetraisopropyl-4,4′-diaminodiphenylmethane, 3,3′,5,5′-tetramethoxy-4,4′-diaminodiphenylmethane, 3,3′,5,5-tetraethoxy-4,4′-diaminodiphenylmethane, 3,3′,5,5′-tetrachloro-4,4′-diaminodiphenylmethane, 3,3′,5,5′-tetrabromo-4,4′-diaminodiphenylmethane, 3,3′,5,5′-tetraisopropyl-4,4′-diaminodiphenylmethane, 3,3′-diisopropyl-5,5′-dimethyl-4,4′-diaminodiphenylmethane, 3,3′-diisopropyl-5,5′-diethyl-4,4′-diaminodiphenylmethane, 4,4′-diaminodiphenylpropane, 3,3′-diaminodiphenylpropane, 3,3′-dimethyl-4,4′-diaminodiphenylpropane, 3,3′-dimethoxy-4,4′-diaminodiphenylpropane, 3,3′-diethoxy-4,4′-diaminodiphenylpropane, 3,3′-dichloro-4,4′-diaminodiphenylpropane, 3,3′-dibromo-4,4′-diaminodiphenylpropane, 3,3′,5,5′-tetramethyl-4,4′-diaminodiphenylpropane, 3,3′,5,5′-tetramethoxy-4,4′-diaminodiphenylpropane, 3,3′,5,5′-tetraethoxy-4,4′-diaminodiphenylpropane, 3,3′,5,5′-tetrachloro-4,4′-diaminodiphenylpropane, 3,3′,5,5′-tetrabromo-4 ,4′-diaminodiphenylpropane, 3,3′-diisopropyl-5,5′-dimethyl-4,4′-diaminodiphenylpropane, 3,3′-diisopropyl-5,5′-diethyl-4,4′-diaminodiphenylpropane, 4,4′-diaminodiphenylsulfone, 3,3′-diaminodiphenylsulfone, 3,3′-dimethyl-4,4′-diaminodiphenylsulfone, 3,3′-dimethoxy-4,4′-diaminodiphenylsulfone, 3,3′-diethoxy-4,4′-diaminodiphenylsulfone, 3,3′-dichloro-4,4′-diaminodiphenylsulfone, 3,3′-dibromo-4,4′-diaminodiphenylsulfone, 3,3′,5,5′-tetraethyl-4,4′-diaminodiphenylsulfone, 3,3′,5,5′-tetramethoxy-4,4′-diaminodiphenylsulfone, 3,3′,5,5′-tetraethoxy-4,4′-diaminodiphenylsulfone, 3,3′,5,5′-tetrachloro-4,4′-diaminodiphenylsulfone, 3,3′,5,5′-tetrabromo-4,4′-diaminodiphenylsulfone, 3,3′-diisopropyl-5,5′-dimethyl-4,4′-diaminodiphenylsulfone, 3,3′-diisopropyl-5,5′-diethyl-4,4′-diaminodiphenylsulfone, 4,4′-diaminodiphenylsulfide, 3,3′-diaminodiphenylsulfide, 3,3′-dimethyl-4,4′-diaminodiphenylsulfide, 3,3′-dimethoxy-4,4′-diaminodiphenylsulfide, 3,3′-diethoxy-4,4′-diaminodiphenylsulfide, 3,3′-dichloro-4,4′-diaminodiphenylsulfide, 3,3′-dibromo-4,4′-diaminodiphenylsulfide, 3,3′,5,5′-tetramethyl-4,4′-diaminodiphenylsulfide, 3,3′,5,5′-tetramethoxy-4,4′-diaminodiphenylsulfide, 3,3′,5,5′-tetraethoxy-4,4′-diaminodiphenylsulfide, 3,3′,5,5′-tetrachloro-4,4′-diaminodiphenylsulfide, 3,3′,5,5′-tetrabromo-4,4′-diaminodiphenylsulfide, 1,4-bis(4-aminophenoxy)benzene, 1,3-bis(4-aminophenoxy)benzene, 2,2-bis(4-aminophenoxyphenyl)propane, bis(4-aminophenoxyphenyl )sulfone, bis(4-aminophenoxyphenyl)sulfide, bis(4-aminophenoxyphenyl)biphenyl, 4,4′-diaminodiphenylether-3-sulfonamide, 3,4′-diaminodiphenylether-4-sulfonamide, 3,4′-diaminodiphenylether-3′-sulfonamide, 3,3′-diaminodiphenylether-4-sulfonamide, 4,4′-diaminodiphenylmethane-3-sulfonamide, 3,4′-diaminodiphenylmethane-4-sulfonamide, 3,4′-diaminodiphenylmethane-3′-sulfonamide, 3,3′-diaminodiphenylmethane-4-sulfonamide, 4,4′-diaminodiphenylsulfone-3-sulfonamide, 3,4′-diaminodiphenylsulfone-4-sulfonamide, 3,4′-diaminodiphenylsulfone-3′-sulfonamide, 3,3′-diaminodiphenylsulfide-4-sulfonamide, 4,4′-diaminodiphenylsulfide-3-sulfonamide, 3,4′-diaminodiphenylsulfide-4-sulfonamide, 3,3′-diaminodiphenylsulfide-4-sulfonamide, 3,4′-diaminodiphenylsulfide-3′-sulfonamide, 1,4-diaminobenzene-2-sulfonamide, 4,4′-diaminodiphenylether-3-carbonamide, 3,4′-diaminodiphenylether-4-carbonamide, 3,4′-diaminodiphenylether-3′-carbonamide, 3,3′-diaminodiphenylether-4-carbonamide, 4,4′-diaminodiphenylmethane-3-carbonamide, 3,4′-diaminodiphenylmethane-4-carbonamide, 3,4′-diaminodiphenylmethane-3′-carbonamide, 3,3′-diaminodiphenylmethane-4-carbonamide, 4,4′-diaminodiphenylsulfone-3-carbonamide, 3,4′-diaminodiphenylsulfone-4-carbonamide, 3,4′-diaminodiphenylsulfone-3′-carbonamide, 3,3′-diaminodiphenylsulfone-4-carbonamide, 4,4′-diaminodiphenylsulfide-3-carbonamide, 3,4′-diaminodiphenylsulfide-4-carbonamide, 3,3′-diaminodiphenylsulfide-4carbonamide, 3,4′-diaminodiphenylsulfide-3′-carbonamide, 1,4-diaminobenzene-2-carbonamide, 4-aminophenyl-3-aminobenzoic acid, 2,2-bis(4-aminophenyl)propane, bis(4-aminophenyl)diethylsilane, bis(4-aminophenyl)diphenylsilane, bis(4-aminophenyl)ethylphosphine oxide, bis(4-aminophenyl)-N-butylamine, bis(4-aminophenyl)-N-methylamine, N-(3-aminophenyl)-4-aminobenzamide, 2,4-bis(β-amino-t-butyl)toluene, bis(p-β-amino-t-butylphenyl)ether, bis(p-βmethyl-γ-aminopentyl)benzene, bis-p-(1,1-dimethyl-5-aminopentyl)benzene, hexamethylenediamine, heptamethylenediamine, octamethylenediamine, nonamethylenediamine, decamethylenediamine, tetramethylenediamine, propylenediamine, 3-methylheptamethylenediamine, 4,4′-dimethyl heptamethylenediamine, 2,11-diaminododecane, 1,2-bis(3-aminopropoxy) ethane, 2,2-dimethylpropylenediamine, 3-methoxyhexamethylenediamine, 2,5-dimethylhexamethylenediamine, 2,5-dimethylheptamethylenediamine, 5-methylnonamethylenediamine, 2,17-diaminoeicosadecane, 1,4-diaminocyclohexane, 1,10-diamino-1,10-dimethyldecane, 1,12-diaminooctadecane, and the like. The diamines may be used alone or in combination.

Silicondiamines may be used as a part of the diamines. Examples of the silicondiamines include 1,3-bis(3-aminopropyl)-tetraphenyldisiloxane, 1,3-bis(3-aminopropyl)-tetramethyldisiloxane, 1,3-bis(4-aminobutyl)-tetra methyldisiloxane, and the like. The amount of the silicondiamine used is preferably 0.1 to 10 mol % based on the total weight of the diamines.

Two or more kinds of the tetracarboxylic dianhydrides and the diamines may be used.

The solution of a precursor of the polyimide resin may be those having light-sensitivity.

The solution of a precursor of the polyimide resin may be coated on the substrate surface by a spinner or printing and heat-treated and cured at a final temperature of 200 to 400° C. to form a coating of a fluorine-free polyimide resin. The thickness of the fluorine-free polyimide resin coating may be adjusted by changing the concentration and/or viscosity of the polyimide precursor solution, or the number of rotation of a spinner.

The thickness of the fluorine-free polyimide resin coating is preferably not more than 10 μm. If it exceeds 10 μm, the total thickness of the fluorine-free resin coating and the fluorine-containing polyimide resin coating becomes too large and is liable to form camber due to a stress caused by the difference in coefficient of expansion between the substrate and the coating. In addition, it becomes difficult to get uniformity of the thickness of the resin coating as a whole.

The thickness of the fluorine-free polyimide resin coating is more preferably not more than 1.0 μm. The thickness of the fluorine-free polyimide resin coating should be most appropriately selected depending on the construction of an optical waveguide prepared by forming the fluorine-containing polyimide resin coating on the fluorine-free polyimide resin coating. If an optical waveguide wherein a core (an optical waveguide layer) is located directly on the fluorine-free polyimide resin coating is formed, or if an optical waveguide wherein a core and the fluorine-free polyimide resin coating are provided adjacently is formed, that is, if the thickness of a cladding layer located between the fluorine-free polyimide resin coating and the core is small, the fluorine-free polyimide resin coating can be one of the factors that increase the optical loss. Accordingly, it is preferable that the thickness of the fluorine-free polyimide resin coating is small.

Specific thickness thereof should be decided taking into account the substrate, the fluorine-free polyimide resin coating, the refractive indexes of the cladding and the core prepared from the fluorine-containing polyimide resin coating and the height and the width thereof. However, taking the matching with the optical fiber which is a transmission line into consideration, it is in general that the size of the core of optical waveguide of a fluorine-containing polyimide resin coating is about 10 μm and it is desirable that the thickness of the fluorine-free polyimide resin coating is not more than 1/10 of the core layer thickness, in particular, not more than 1.0 μm, more preferably about 0.5 μm in the above example.

A solution of the polyimide precursor is coated on the substrate surface by a spinner or a method such as printing, heated and cured at a final temperature of 200-400° C. to form a fluorine-containing polyimide resin coating. The fluorine-containing polyimide resin coating is optionally etched by conventional method or irradiated with electromagnetic wave including light or particle beam including electron beam to form an optical waveguide. The optical waveguide can be formed by the use of plural fluorine-containing polyimide resin coatings having different refraction indexes by conventional method.

### EXAMPLES

The present invention will hereunder be explained more specifically with reference to the following working examples to which the present invention is not limited.

### Example 1

(Preparation of a Solution of Organic Zirconium Compound)

Tributoxyacetylacetonate zirconium was dissolved in butanol to obtain a 1% by weight solution of an organic zirconium compound.

(Preparation of a Fluorine-Free Polyimide Precursor Solution)

4,4′-Diaminodiphenylether (35.33 g) and 4,4′-diaminodiphenylether-3-carbonamide (4.77g) were dissolved in N-methyl-2-pyrrolidone (528.3 g), to which 3,3′,4,4′-benzophenonetetracarboxylic dianhydride (31.69 g) and pyromellitic dianhydride (21.44 g) were added and stirred at room temperature for 6 hours to obtain a fluorine-free polyimide precursor solution.

(Preparation of a Fluorine-Containing Polyimide Precursor Solution)

2,2-Bis(4-aminophenyl)hexafluoropropane (21.47 g) was dissolved in N,N-dimethylacetamide (450 g), to which 2,2′-bis(3,4-dicarboxyphenyl hexafluoropropanoic dianhydride (28.53 g) were added and stirred at room temperature for 20 hours to obtain a fluorine-containing polyimide precursor solution.

(Preparation of Organic Zirconium Compound Coating)

Silicon wafer having the diameter of 5 inches on which surface 2μm thick SiO₂ coating had been formed was used as a substrate. On the substrate, the organic zirconium compound solution was dropped, spin-coated at 3000 rpm for 30 seconds and dried on a hot plate at 200° C. for 5 minutes to obtain an organic zirconium compound coating whose thickness was about 200 Å.

(Preparation of Fluorine-Free Polyimide Resin Coating)

On the organic zirconium compound coating, the fluorine-free polyimide precursor solution was dropped, spin-coated at 2000 rpm for 30 seconds and cured in an oven (100° C./30 minutes+200° C./30 minutes+350° C./60 minutes) to obtain a fluorine-free polyimide resin coating.

(Preparation of Fluorine-Containing Polyimide Resin Coating)

On the fluorine-free polyimide resin coating, the fluorine-containing polyimide precursor solution was dropped, spin-coated at 2000 rpm for 30 seconds and cured in an oven (100° C./30minutes +200° C./30minutes+350° C./60 minutes) to obtain a fluorine-containing polyimide resin coating.

### Comparative Example 1

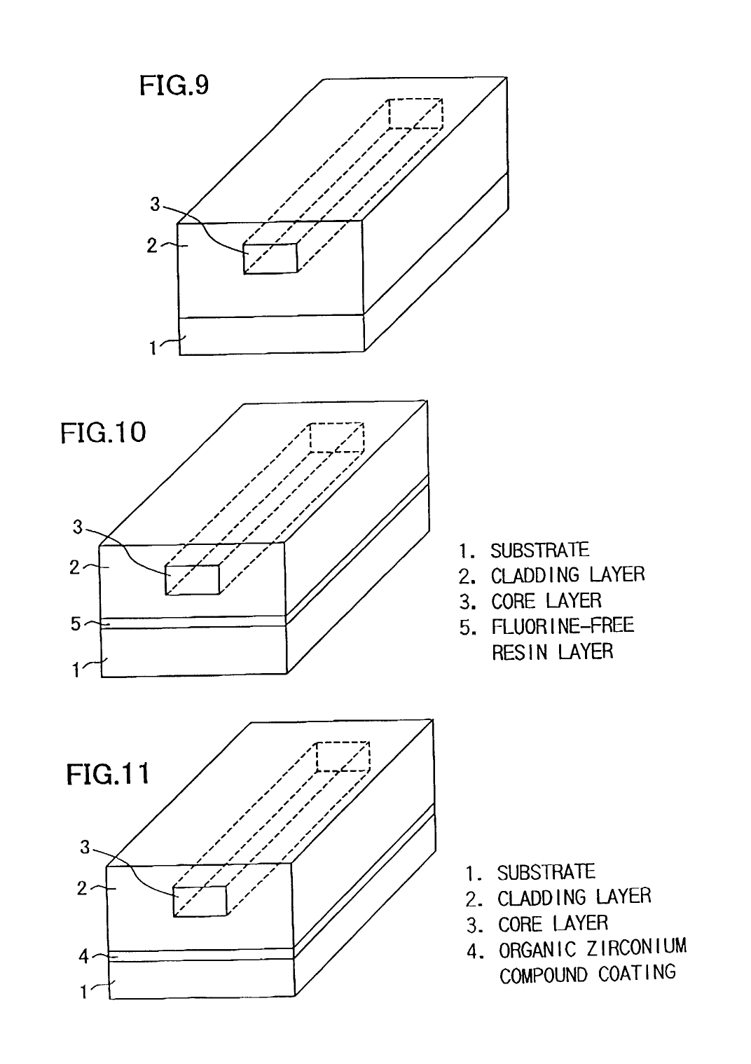

Without forming an organic zirconium compound coating and a fluorine-free polyimide resin coating, a fluorine-containing polyimide resin coating was formed directly on the substrate under the same conditions as mentioned above to obtain a comparative sample (see FIG. 9).

### Comparative Example 2

Without forming an organic zirconium compound coating, a fluorine-free polyimide resin coating alone was formed on the substrate and then a fluorine-containing polyimide resin coating was formed under the same conditions as mentioned above to obtain a comparative sample (see FIG. 10).

### Comparative Example 3

An organic zirconium compound coating alone was formed on the substrate and then a fluorine-containing polyimide resin coating was formed under the same conditions as mentioned above without forming a fluorine-free polyimide resin coating to obtain a comparative sample (see FIG. 11).

(Evaluation of Adhesive Property)

Adhesive property was evaluated according to quasi cross-cut adhesion test of JISK5400. Namely, a polyimide coating was cut into 100 squares of 1 mm×1 mm with a cutter knife and cellophane-tape was adhered and then peeled off. The number of squares from which the cellophane-tape had not been peeled off was counted.

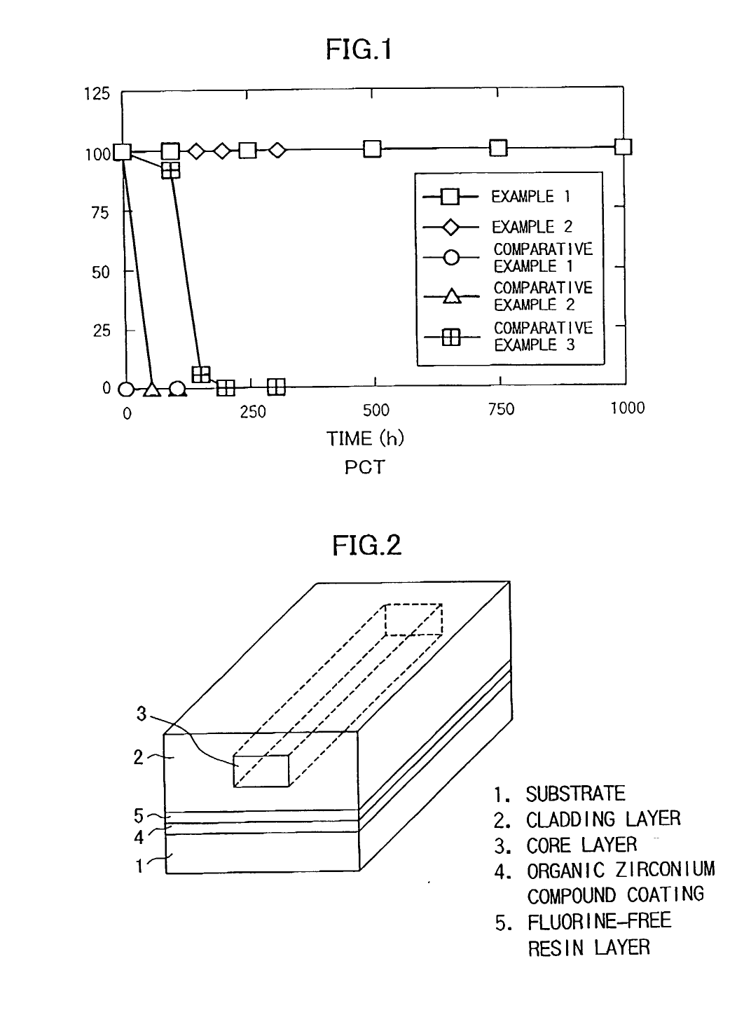

Decrease of the adhesive property due to water was measured by the Pressure-Cooker Test at 121° C. and 2 atmospheric pressure. The results of the adhesive property test are shown in FIG. 1. Samples of Examples 1 and 2 show much higher adhesive property than those of Comparative Examples 1 to 3.

FIG. 2 shows a channel polymer optical waveguide of another working example of the present invention. This waveguide comprises an organic zirconium compound coating 4 and a fluorine-free resin layer 5 between a substrate 1 and a cladding layer 2. The fluorine-free resin layer 5 may comprise an optional polymer having high adhesive property to the substrate. For example, if a fluorinated polyimide resin is used in the cladding layer 2, a fluorine-free polyimide may be used in the fluorine-free resin layer 5 to obtain high adhesive property to the substrate. A polyimide silicone resin having silicon atom in the molecule and strong self-adhesion property may be used in the fluorine-free resin layer 5. A fluorine-free acrylic resin or a fluorine-free polycarbonate resin may also be used in the fluorine-free resin layer 5.

With reference to FIG. 2, the present invention will be explained more specifically. First, the organic zirconium compound coating 4 was formed on the silicon substrate 1, and then, an N,N-dimethylacetamide solution of a polyamic acid which is a precursor of a polyimide silicone resin was coated by a spinner and cured to form a fluorine-free resin layer 5 (thickness: 1.5 μm) consisting of the polyimide silicone resin. The polyimide silicone resin used herein was a polymerization product of benzophenone tetracarboxylic dianhydride (BTDA), methylenedianiline (MDA) and bis-γ-aminopropyltetramethyl disiloxane (GAPD) and represented by the following formula.

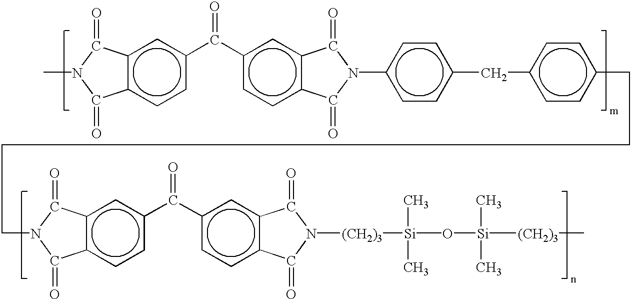

Then, an N,N-dimethylacetamide solution of a polyamic acid which is a precursor of a fluorinated polyimide resin A was coated and cured to form a cladding layer 2 consisting of the polyimide resin A (thickness: 10 μm) and then, an N,N-dimethylacetamide solution of a polyamic acid which is a precursor of a fluorinated polyimide resin B was coated and cured to form a core layer 3 consisting of the polyimide resin B (thickness: 7 μm).

The polyimide resin A was a polymerization product of 2,2′-bis(trifluoromethyl)-4,4′-diaminobiphenyl (TFDB) and 2,2′-bis(3,4-dicarboxyphenyl)hexafluoropropane dianhydride(6FDA) and represented by the following formula.

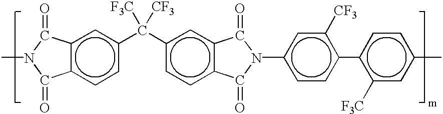

The polyimide resin B was a polymerization product of TFDB, 6FDA and pyromellitic dianhydride (PMDA) and represented by the following formula.

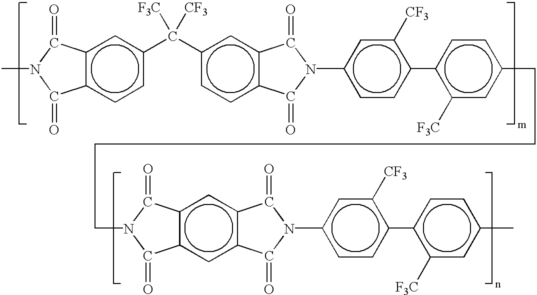

The ratio of 6FDA to PMDA in the polyimide B (that is, the ratio of m to n) was 4:1 so that the refractive index of the core layer 3 was about 0.3% greater than that of the cladding layer 2.

Oxygen reactive ion etching was conducted to remove a part of the core layer 3 to form an optical waveguide pattern. Then, an N,N-dimethylacetamide solution of the polyamic acid which is the precursor of the fluorinated polyimide resin A was coated and cured to form a cladding layer 2 consisting of the polyimide resin A (thickness: 10 μm).

The transmission loss in the optical waveguide thus prepared was 0.3 dB/cm in wavelength of 1.3 μm. This loss was as small as that in the prior art optical waveguide (FIG. 9) prepared by the use of the same fluorinated polyimide resin.

The optical waveguides thus prepared were examined by the Pressure-Cooker Test. The cladding layer 2 was peeled off from the substrate 1 in the prior art optical waveguide (FIG. 9), the optical waveguide containing the fluorine-free resin layer 5 alone (FIG. 10) and the optical waveguide containing the organic zirconium compound coating 4 alone (FIG. 11). In contrast, there was no peeling off between the cladding layer 2 and the substrate 1 in the optical element of the present invention containing both the organic zirconium compound coating 4 and the fluorine-free resin layer 5.

The above results demonstrate the increase in the adhesive property and the long-term reliability of the optical element.

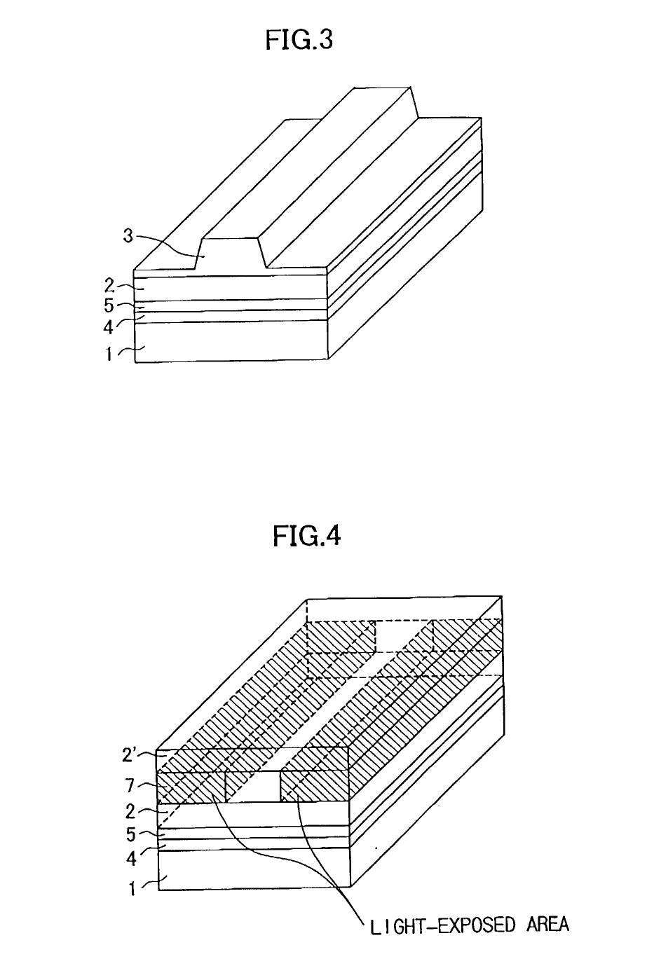

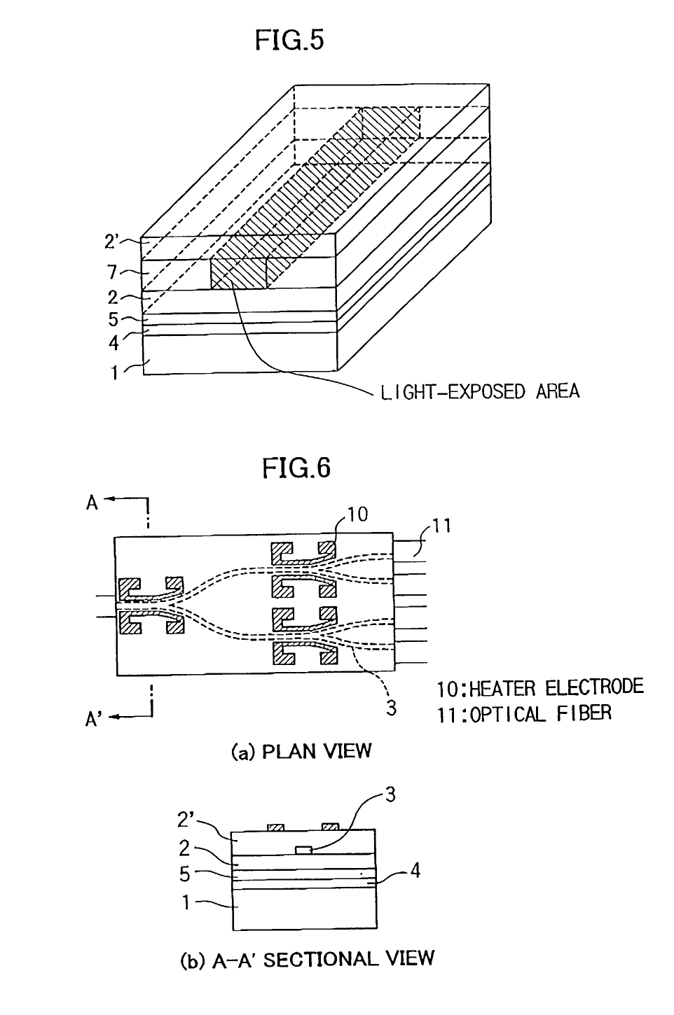

The present invention has been explained with reference to the preparation of a specific channel optical waveguide by etching method. However, the present invention can also be applied to a ridge optical waveguide having no upper cladding layer as shown in FIG. 3. Moreover, the present invention can be applied to a channel optical waveguide prepared by light-exposing a part of a core layer comprising a light-sensitive polymer to decrease the refractive index of the exposed areas as shown in FIG. 4. Further, the present invention can be applied to a channel optical waveguide prepared by light-exposing a part of a core layer comprising a light-sensitive polymer different from that used in the waveguide as shown in FIG. 4 to increase the refractive index of the exposed areas as shown in FIG. 5. The substrate or the surface of the substrate may be of any inorganic materials such as SiO₂, quartz and SiNₓ, which will produce the same advantage as described above.

FIGS. 6 (a) and (b) show an optical switch which is an example of a polymer optical integrated circuit of the present invention. This 1×4 optical switch comprises a thin film heater electrode 10 on the waveguide which is heated by the heater to change the refractive index of the waveguide to thereby switch the optical path. The optical switch was prepared as follows. In the similar manner to that in the former example, an organic zirconium compound coating 4 was formed on the silicone substrate 1. Then, an N,N-dimethylacetamide solution of a polyamic acid which is a precursor of a polyimide silicone resin, an N,N-dimethylacetamide solution of a polyamic acid which is a precursor of a fluorinated polyimide resin A and an N,N-dimethylacetamide solution of a polyamic acid which is a precursor of a fluorinated polyimide resin B were coated in this order and cured to form a fluorine-free resin layer 5 of the polyimide silicone resin (thickness: 1.5 μm), a lower cladding layer 2 of the fluorinated polyimide resin A (thickness: 10 μm) and a core layer 3 of the fluorinated polyimide resin B (thickness: 7 μm). Then, oxygen reactive ion etching was conducted to remove a part of the core layer to form an optical waveguide pattern including branching structure. A solution of polyamic acid which is a precursor of a fluorinated polyimide resin A was coated and cured to form a upper cladding layer 2′ of the fluorinated polyimide resin A on which a Cr thin film heater 10 was provided. Finally, optical fibers 11 (5 fibers in total) to input and output the light were adhesive-bonded. The insert loss of the optical switch thus prepared was about 4 dB and switching occurred at 20 dB or more of optical extinction ratio by applying an electric power of about 40 mW to each heater. The polymer was not peeled off from the substrate after the heater current was put on and off more than 10,000 times. In contrast, the polymer waveguide was peeled off from the substrate in the prior art element not comprising the organic zirconium compound coating and the fluorine-free resin layer when the heater current was put on and off.

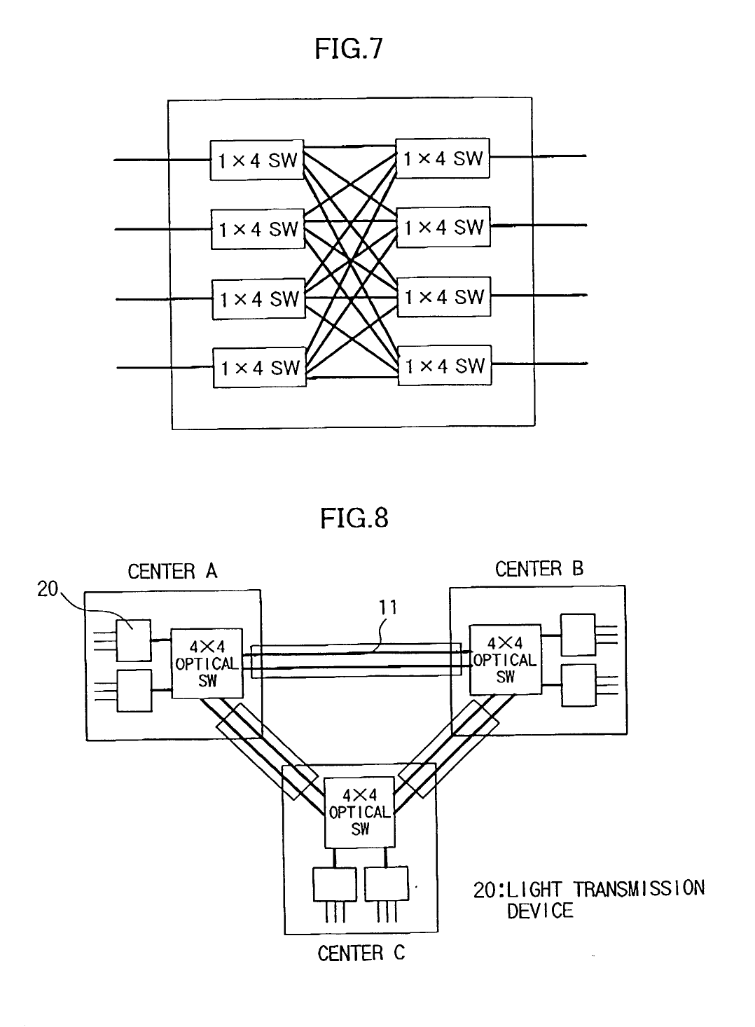

The 1×4 optical switches were combined to construct 4×4 optical switch as shown in FIG. 7.

The 4×4 optical switches were set up in each center to construct an optical communication system as shown in FIG. 8. In the optical communication system, each of center A and center B, center B and center C, and center C and center A communicates with each other by a single optical fiber of the shortest distance. However, if, for example, an optical fiber between center A and center B is break down, the optical switches in each center can be switched so that communication between center A and center B is conducted through the optical fiber between center A and center C, the optical switch in center C, and the optical fiber between center C and center B. Thus, the optical communication system operates normally for a long period of time.

The above examples demonstrate that the present invention provides a polymer optical waveguide, an optical integrated circuit and an optical module which have high adhesive property with the substrate and high reliability. Moreover, the polymer optical waveguide, the optical integrated circuit and the optical module of the present invention can be used to construct an optical communication system having higher reliability. Accordingly, the present invention has high industrial applicability.

What is claimed is:

1. An optical element comprising a substrate having provided thereon a coating of an organic zirconium compound, a coating of a fluorine-free resin and a coating of a fluorine-containing polyimide resin, in this order.

2. The optical element of claim 1 wherein the coating of the fluorine-free resin has a thickness of 10 82 m or less.

3. The optical element of claim 1 wherein the coating of the fluorine-free resin has a thickness of 10 μm or less.

4. A method for the production of an optical element comprising the steps of providing a substrate; forming a coating of an organic zirconium compound on the surface of the substrate; forming a coating of a fluorine-free resin on the coating of the organic zirconium compound and forming a coating of a fluorine-containing polyimide resin on the coating of the fluorine-free resin.

5. The method of claim 4 wherein the coating of the fluorine-free resin has a thickness of 10 μm or less.

6. The method of claim 4 wherein the coating of the fluorine-free resin has a thickness of 10 μm or less.

7. An optical module comprising a polymer optical waveguide comprising a substrate having provided thereon a coating of an organic zirconium compound, a coating of a fluorine-free resin and a coating of a fluorine-containing polyimide resin, in this order, wherein at least one of a light emitting element, a light detecting element and an optical fiber is provided at one or both ends of the polymer optical waveguide.
